(19) United States
(12) Patent Application Publication
(10) Pub. No.: US 2012/0094031 A1
(43) Pub. Date: Apr. 19, 2012

(54) METHOD AND COATING PLANT FOR PROVIDING A WORKPIECE WITH A COATING

(75) Inventors: Bernhard Schmitt, Birkenau (DE); Gerald Dalibor, Sindelfingen (DE); Jerzy Mrozek, Munzenberg (DE); Jorg Fojtzik, Marbach (DE)

(73) Assignee: DURR SYSTEMS GMBH, Bietigheim-Bissingen (DE)

(21) Appl. No.: 13/301,310

(22) Filed: Nov. 21, 2011

Related U.S. Application Data
(63) Continuation of application No. PCT/EP2010/056869, filed on May 19, 2010.

(30) Foreign Application Priority Data
May 22, 2009 (DE) 10 2009 023 115.3

(51) Int. Cl. B05D 3/00; B05C 9/12; B05D 3/06

(52) U.S. Cl. 427/541; 427/372.2; 427/294; 118/58

(57) ABSTRACT

In order to produce a method of providing a workpiece with a coating comprising the following process steps: —coating the workpiece: and —drying the workpiece by means of a drying device which is of increased capacity and is also particularly suitable for very long workpieces, there is proposed a method wherein the workpiece is moved relative to the drying device after the process of coating the workpiece has begun and before the process of drying the workpiece has terminated.

### RELATED APPLICATION

This application is a continuation application of PCT/EP2010/056869 filed on May 19, 2010, the entire specification of which is incorporated herein by reference.

### FIELD OF DISCLOSURE

The present invention relates to a method for providing a workpiece with a coating comprising the following processing steps:
coating the workpiece; and
drying the workpiece by means of a drying device.

### BACKGROUND

It is known for a workpiece that is to be provided with a coating to be introduced into a processing booth and for the workpiece to be arranged statically in the processing booth whilst being coated manually or by means of automatic coating devices. Subsequently, the processing booth is heated in order to dry the coated workpiece. After the workpiece has been dried and the processing booth subsequently cooled, the workpiece is removed from the processing booth. During the entire phase of operation, which may also include a pre-treatment phase and an evaporation phase, the workpiece does not move relative to the processing booth which is also serving, inter alia, as a drying device.

In this known method, the overall processing time for a workpiece is made up of the combined times needed for the coating of the workpiece, the heating of the processing booth, the drying of the workpiece and the cooling of the processing booth, this thus limiting the capacity of the coating plant and the coating process being carried out therein.

### SUMMARY OF THE INVENTION

The object of the present invention is to produce a method for providing a workpiece with a coating of the type mentioned hereinabove which is of increased capacity and is also particularly suitable for very long workpieces.

In accordance with the invention, this object is achieved in the case of a method incorporating the features according to the preamble of claim 1 in that the workpiece is moved relative to the drying device after the process of coating the workpiece has begun and before the process of drying the workpiece has terminated.

The present invention is thus based on the concept of not keeping the workpiece static relative to the drying device during the entire phase of operation comprising the processes of coating and drying the workpiece but rather of moving it relative to the drying device at least in the period between the beginning of the process of applying the coating to the workpiece and the conclusion of the process of drying the workpiece.

It is thereby possible to significantly reduce the total amount of time needed for the treatment of a workpiece.

In connection therewith, the relative movement between the workpiece and the drying device can be produced by a movement of the workpiece whilst the drying device is stationary, by a movement of the drying device whilst the workpiece is stationary or else by means of a simultaneous movement of the workpiece and the drying device.

In a special embodiment of the method in accordance with the invention, the workpiece is moved both during the coating process and during the drying process.

In connection therewith, provision may be made, in particular, for the workpiece to be advanced in a continual process, either intermittently or preferably continuously, through a coating zone and a drying zone located behind the coating zone in the direction of advancement of the workpiece. It is thereby possible to carry out the processes of coating and drying the workpiece simultaneously at different parts of the workpiece whereby a very considerable reduction in the total processing time that is necessary for each workpiece is obtained.

Moreover, the continual process enables both the coating zone and the drying zone to be made significantly shorter than the workpiece that is to be coated.

If, apart from the process of coating and the process of drying, yet further processing steps are effected on the workpiece such as a pre-treatment process and/or an evaporation process for example, then these additional processes can likewise be carried out in separate zones, thus for example in a pre-treatment zone and in an evaporation zone having a length which can be shorter than the length of the workpiece that is to be coated.

A significant saving in energy is obtained due to the smaller booth size of the individual zones and the consequential reduction in the volume of air flowing through these zones.

Furthermore, it is no longer necessary to heat the entire processing booth for the purposes of drying the workpiece and then having to cool it down again after the workpiece has been dried, this likewise contributing to a significant saving in energy.

Furthermore, the coating plant used for carrying out the method does not have to be dimensioned in dependence upon the size of the workpiece, but can be designed in dependence on the desired throughput.

In a further embodiment of the method, provision is made for the workpiece to be moved, preferably continuously, after the process of coating the workpiece is concluded and whilst the workpiece is being dried.

In this case in particular, provision may be made for the process of drying the workpiece to take place in the continual operational mode, whilst the process of coating the workpiece is effected whilst the workpiece is stationary.

In this case, further processing steps, such as a pre-treatment process and an evaporation process in particular, can also be carried out whilst the workpiece is stationary.

In a further embodiment of the method, provision is made for the drying device to be moved, preferably continuously, whilst the workpiece is being dried.

In this case, the coating process can be carried out with a stationary workpiece.

In this case too, further processing steps such as a pre-treatment process and an evaporation process for example, can also be carried out whilst the workpiece is stationary.

The workpiece can also remain stationary during the drying process. Since, in this case, the workpiece is not being advanced in the continual operational mode whilst it is being processed in the processing booth, a conveyor device of simpler construction can be used for advancing the workpiece since lesser demands are then imposed on the quiet running of the workpiece conveyance process.

In a further embodiment of the method, provision may be made for the workpiece to be moved relative to the drying device after the process of coating the workpiece is concluded but before the process of drying the workpiece begins.

In this case, both the process of coating the workpiece and that of drying the workpiece can be effected whilst the workpiece is stationary. It is sufficient for the workpiece to move from a coating zone into a drying zone between the coating process and the drying process. Since, in this case, no processing steps are being performed on a moving workpiece, the conveyor device for advancing the workpiece can be of simpler construction than it would be for continual operation due to the fact that lesser demands are being imposed on the smooth running of the workpiece moving process.

In a preferred embodiment of the invention, the workpiece is advanced substantially continuously through a processing booth of the coating plant during the coating process and/or during the drying process.

In this connection, the speed at which the workpiece is conveyed preferably amounts to between 0.2 m/min and 1 m/min.

In particular, the workpiece can be moved relative to the drying device by means of a track-guided workpiece carriage.

The conveyor device in the coating plant used for carrying out the method in accordance with the invention preferably comprises a longitudinal conveyor track along which the workpiece carriage is movable in a longitudinal direction of advancement, and a transverse conveyor track along which the workpiece carriage is movable in a transverse direction of advancement running transversely relative to the longitudinal direction of advancement.

In order to enable the workpiece carriage to move outside of a processing booth of the coating plant and back from the exit of the processing booth to the entrance of the processing booth, the conveyor device preferably comprises a return conveyor track over which the workpiece carriage is moveable in the reverse direction from an end of the longitudinal conveyor track to the beginning of the longitudinal conveyor track.

Preferably the return conveyor track runs outside the processing booth of the coating plant.

In particular, the return conveyor track can run substantially parallel to the longitudinal conveyor track.

In a preferred embodiment of the method in accordance with the invention, provision is made for the workpiece to be moved by means of a self-propelled workpiece carriage.

In order to supply a drive device of the self-propelled workpiece carriage with the requisite electrical energy, provision may be made for the conveyor device of the coating plant to be provided with a device for transmitting energy to the workpiece carriage in non-contact-making manner.

As an alternative or in addition to such a process of transmitting energy in non-contact-making manner, provision may be made for the workpiece carriage to have a storage means for electrical energy, in particular, an accumulator.

In order to enable the workpiece carriage to move in both a longitudinal direction of advancement and in a transverse direction of advancement running transversely relative thereto, it is expedient for the workpiece carriage to be moved by means of a first set of running wheels in a first direction and by means of a second set of running wheels in a second direction which runs transversely relative to the first direction.

In particular, the workpiece carriage may have longitudinally running wheels for the longitudinal transportation process in a longitudinal direction of advancement and transversely running wheels for a transverse transportation process in a transverse direction of advancement running transversely relative to the longitudinal direction of advancement.

Preferably, the longitudinally running wheels and/or the transversely running wheels are arranged on the workpiece carriage in height adjustable manner so that the workpiece carriage can be switched over from the longitudinal transportation mode to the transverse transportation mode or from the transverse transportation mode to the longitudinal transportation mode by lowering or raising these running wheels.

In order to achieve the effect that the workpiece carriage runs as smoothly as possible, provision may be made for the workpiece carriage to be guided on at least one rail which has a curved, preferably convex, bearing surface.

In particular, such a rail can be in the form of a round rail.

In this case, the workpiece carriage preferably has at least one running wheel which has a curved, preferably concave, running surface along the periphery thereof that is complementary to the curved bearing surface of the rail.

In order to prevent the rail on which the workpiece carriage is being guided from becoming contaminated, the rail in the coating zone of the coating plant is preferably separated by a shielding element, for example a casing, from an application area of the coating zone within which the coating material is applied to the workpiece.

In a preferred embodiment of the invention, provision is made for the workpiece to be pre-treated before the coating process in order to activate the workpiece surface that is to be coated.

In connection therewith, provision may be made for the workpiece to be pre-treated prior to the coating process by means of a vacuum suction-jet device which is preferably fixed on a robot-guided or automatic carriage unit.

In such a vacuum suction-jet device, an abrasive medium is blasted onto the surface of the workpiece and immediately sucked off again under a hood which is held on the workpiece by suction so that no dust is produced outside the hood.

As an alternative or in addition thereto, provision may be made for the workpiece to be pre-treated prior to the coating process by means of a robot-guided brushing system incorporating a suction device.

The process of coating the workpiece can be effected, in principle, using any form of coating material.

Preferably, a lacquer and in particular a solvent-free lacquer such as a water lacquer for example is used for the coating process.

The process of coating the workpiece is preferably effected in a coating zone in which excess coating material is picked up by an air stream, whereby the superfluous coating material is separated out of the air stream by means of a separation device.

This separation device is preferably in the form of a dry separation device.

In particular, such a dry separation device can comprise filter elements that are coverable with a pre-coat material.

On the pre-coat layer consisting of such a pre-coat material, stone dust for example, sticky particles in the coating material can settle.

As an alternative or in addition thereto, the dry separation device may comprise labyrinth filters for the separation of the coating material.

The process of drying the workpiece can be effected by supplying warm air to the workpiece for example.

The drying device by means of which the workpiece is dried can be in the form of a convection dryer for example.

As an alternative or in addition thereto, provision may be made for the coating produced on the workpiece to be dried and/or hardened at least partially by means of an irradiation unit.

In connection therewith, the irradiation unit can emit infrared radiation and/or UV radiation (in the case of a coating that is curable by UV irradiation) for example.

Furthermore, a cooling device for cooling the at least one irradiation device can be provided.

The at least one irradiation unit can be fixed in place in a drying zone.

As an alternative thereto, provision may be made for the at least one irradiation unit to be moveable, preferably in the longitudinal direction of a processing booth of the coating plant, so that a larger area of the surface of the workpiece can be swept over by this irradiation unit without the workpiece itself having to be moved relative to the irradiation unit.

Particularly in the case where the cross sectional geometry of the workpiece varies in the longitudinal direction thereof, it is of advantage for the irradiation unit to comprise at least one irradiation device which is movable relative to the coated surface of the workpiece so that the distance thereof from the coated surface of the workpiece is adjustable in a variable manner. In this way, the position of the irradiation device can be adapted to the varying cross sectional geometry of the workpiece thereby achieving a uniform intensity of irradiation on all the surfaces of the workpiece.

The air being supplied to the processing booth of the coating plant is preferably fed through an air re-circulating system thereby achieving a considerable saving of energy because it is not then necessary to constantly warm up fresh air to the temperature needed in the processing booth.

Furthermore, it is expedient for the coating plant to comprise a plurality of air re-circulating systems so that the atmosphere in the booth can be conditioned in differing manners in the different air re-circulating systems in dependence upon the requirements.

In particular, it is expedient for there to be a first air re-circulating system which feeds a supply of air to a pre-treatment zone, and a second air re-circulating system which feeds a supply of air to a coating zone so that the air supply for the pre-treatment zone on the one hand and that for the coating zone on the other are conditionable in different manners.

Furthermore, it is expedient for the processing booth to comprise a plurality of mutually separated zones to each of which the air is supplied via its own air supply line because the quantity of air being supplied in this way to a particular zone can then be precisely adapted to its particular requirements. A further saving of energy is obtained by such a sectionalised air supply system.

The process of drying the workpiece is preferably effected in a drying zone having a longitudinal extent in the direction in which the workpiece is being moved relative to the drying device which is smaller than the longitudinal extent of the workpiece in this direction.

In like manner, it is expedient for the process of coating a workpiece to be effected in a coating zone having a longitudinal extent in the direction in which the workpiece is being moved relative to the drying device which is smaller than the longitudinal extent of the workpiece in this direction.

Preferably, all the processing steps that are to be carried out on the workpiece in the coating plant are effected fully automatically when the plant is operating normally.

However, provision can be made for the processing booth of the coating plant to comprise at least one reserve zone or back-up zone in which it is feasible for manual treatment of the workpiece to be effected.

In this way, it is then possible for the workpiece to be properly coated even if an automatically operated processing zone preceding it in the direction of advancement of the workpiece fails or if a defective product is produced so that a manual touching-up process is necessary.

In particular, provision may be made for such a reserve zone or back-up zone to be arranged between a pre-treatment zone and a coating zone of the coating plant.

As an alternative or in addition thereto, provision may also be made for such a reserve zone or back-up zone to be arranged between a coating zone and a drying zone of the coating plant.

The coating process in accordance with the invention is suitable in particular for the coating of very long workpieces and especially elongated workpieces wherein the longitudinal extent thereof is significantly greater than the maximum extent thereof in a transverse direction running perpendicularly with respect to the longitudinal direction of the workpiece.

Preferably, the longitudinal extent of the workpiece is at least five times greater than the maximum transverse extent of the workpiece.

The workpiece that is to be coated is preferably an individual part of a given longitudinal extent, i.e. not a tape-like material of indefinite length.

Furthermore, the present invention relates to a coating plant for providing a workpiece with a coating wherein said plant comprises at least one coating unit by means of which the workpiece is providable with a coating, and at least one drying device by means of which the coating on the workpiece is dryable.

The further object of the present invention is to provide such a coating plant which is of increased capacity and is particularly suitable for the coating of very long workpieces.

In accordance with the invention, this object is achieved in the case of a coating plant incorporating the features of the preamble of claim 16 in that the coating plant comprises at least one moving device by means of which a relative movement between the workpiece and the drying device is producible after the process of coating the workpiece has begun and before the process of drying the workpiece is terminated.

Such a coating plant is particularly suitable for carrying out the method in accordance with the invention.

The moving device can be constructed in such a way as to cause the workpiece to move and/or the drying device to move.

In particular, the moving device can comprise a workpiece carriage and/or a movable irradiation unit for drying the workpiece.

Further features and advantages of the invention form the subject matter of the following description and the graphical illustration of exemplary embodiments.

### BRIEF DESCRIPTION OF THE DRAWINGS

FIG. 1 shows a schematic plan view of a coating plant incorporating a processing booth extending in a longitudinal direction and a conveyor device which comprises a longitudinal conveyor track running through the processing booth, a return conveyor track running outside of the processing booth and parallel to the longitudinal conveyor track and also transverse conveyor tracks which connect the return conveyor track and the longitudinal conveyor track to one another;

FIG. 2 a schematic sketch of the processing booth in the coating plant depicted in FIG. 1 which comprises a pre-treatment zone, a first back-up zone, an air-lock zone, a coating zone, a further back-up zone, an evaporation zone and a drying zone which succeed one another in the longitudinal direction of the processing booth;

FIG. 3 an air supply diagram which represents the supply of air to and the exhaust of the air from the processing booth depicted in FIG. 2;

FIG. 4 a further schematic sketch of the processing booth incorporating a workpiece carriage which carries a very long workpiece (in the form of a rotor blade for a wind turbine for example) and advances it through the processing booth in a longitudinal direction of advancement, while parts of the workpiece succeeding each other in the longitudinal direction of the workpiece are being treated at the same time in different zones of the processing booth;

FIG. 5 a schematic side view of the workpiece carriage together with the workpiece that is being held thereon;

FIG. 6 a partially schematic vertical cross section through the workpiece carriage and a longitudinal conveyor rail upon which a longitudinal conveyor running wheel of the workpiece carriage is rolling;

FIG. 7 a schematic view of the workpiece carriage, of the workpiece being held thereon and of irradiation devices that are adjustable with respect to the workpiece, along a line of sight in the longitudinal direction of advancement through the coating plant;

FIG. 8 a schematic section through a vacuum suction-jet device which is used for the pre-treatment of the workpiece in the pre-treatment zone;

FIG. 9 a schematic sketch of a processing booth in a second embodiment of a coating plant wherein the pre-treatment and the coating of the workpiece and also the evaporation process are carried out in a common work zone whilst the workpiece is stationary whereafter the workpiece is advanced through a drying zone;

FIG. 10 a schematic sketch of the processing booth in a third embodiment of a coating plant wherein the pre-treatment and the coating of the workpiece and also the evaporation process are carried out in a common work booth whilst the workpiece is stationary whereafter a drying device is moved along the workpiece whilst the workpiece remains stationary; and

FIG. 11 a schematic sketch of the processing booth in a fourth embodiment of a coating plant wherein the pre-treatment and the coating of the workpiece and also the evaporation process are carried out in a common work zone whilst the workpiece is stationary whereafter the workpiece is advanced to a drying zone and dried in the drying zone whilst in a stationary state.

Similar or functionally equivalent elements are designated by the same reference symbols in all of the Figures.

### DETAILED DESCRIPTION OF THE INVENTION

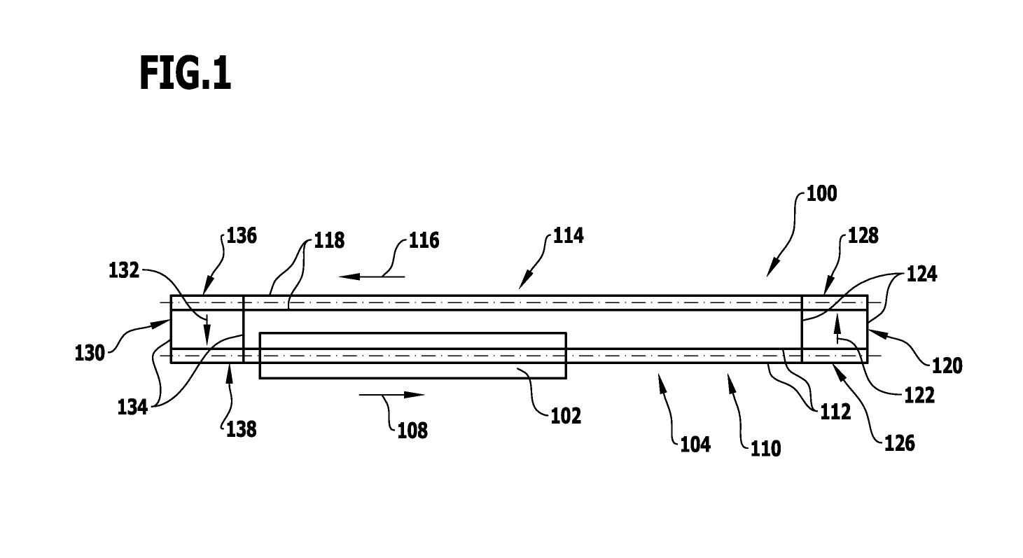

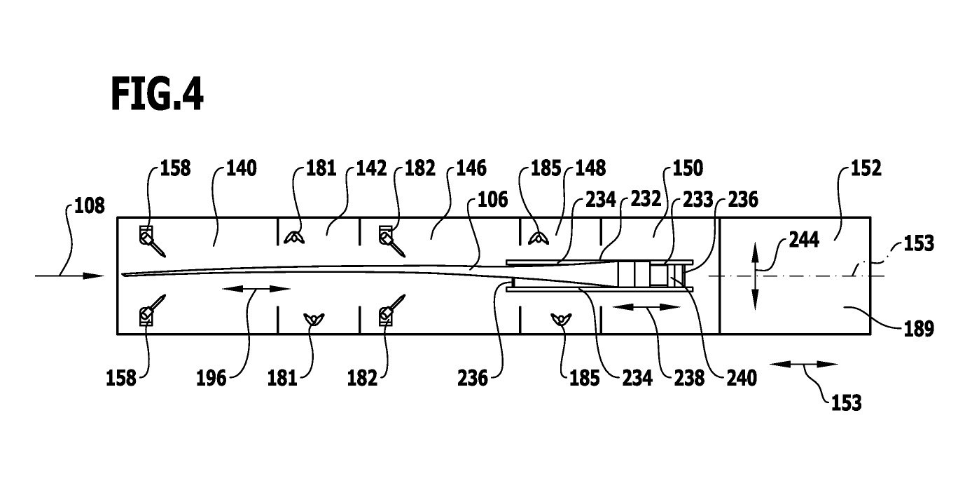

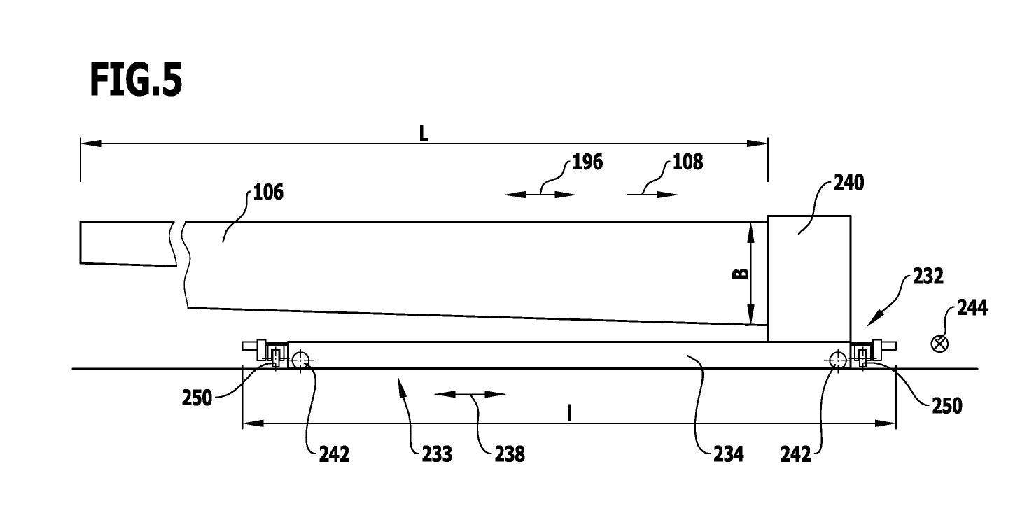

A coating plant which bears the general reference 100 and is illustrated in FIGS. 1 to 8 comprises a processing booth 102 and a conveyor device 104 with the aid of which a workpiece 106 that is to be coated (see FIGS. 4 and 5) is conveyable through the processing booth 102 in a longitudinal direction of advancement 108 (see FIG. 1).

In accordance with the invention, the workpieces that are to be coated are often one-piece units that are intended for use as rotor blades in wind-powered power stations, ships hulls, automobile bodies or aircraft wings or tail units.

A coating plant in accordance with the invention displays special advantages in the case of substrates having a longitudinal extent of 10 m or more, as will be described in more detail hereinafter.

The conveyor device 104 comprises a longitudinal conveyor track 110 which runs in the longitudinal direction of advancement 108 and has two longitudinal conveyor rails 112 that extend in parallel with the longitudinal direction of advancement 108 and are mutually spaced in a direction perpendicular to the longitudinal direction of advancement 108.

Furthermore, in order to enable the workpiece 106 to return after a first coating process in the processing booth 102 from the exit of the processing booth 102 to the entrance of the processing booth 102 for a second coating process, the conveyor device 104 comprises a return conveyor track 114 which runs in a reverse direction of advancement 116 that is parallel to the longitudinal direction of advancement 108 but is opposed thereto.

The return conveyor track 114 comprises two return conveyor rails 118 which run in parallel with the reverse direction of advancement 116 and are mutually spaced in a direction perpendicular to the reverse direction of advancement 116.

In order to enable the workpiece 106 to be conveyed from the end of the longitudinal conveyor track 110 to the beginning of the return conveyor track 114, the end of the longitudinal conveyor track 110 is connected to the beginning of the return conveyor track 114 by a first transverse conveyor track 120 which runs in a first transverse direction of advancement 122 that is oriented perpendicularly with respect to the longitudinal direction of advancement 108 and perpendicularly with respect to the reverse direction of advancement 116.

The first transverse conveyor track 120 comprises two transverse conveyor rails 124 which run in parallel with the first transverse direction of advancement 122 and are mutually spaced in a direction perpendicular to the first transverse direction of advancement 122 and which form a first rail crossing 126 with the longitudinal conveyor rails 112 of the longitudinal conveyor track 110 and a second rail crossing 128 with the return conveyor rails 118 of the return conveyor track 114.

Furthermore, in order to enable the workpiece 106 to be conveyed back from the end of the return conveyor track 114 to the beginning of the longitudinal conveyor track 110, the conveyor device 104 comprises a second transverse conveyor track 130 which runs in a second transverse direction of advancement 132 that is oriented perpendicularly with respect to the reverse direction of advancement 116 and perpendicularly with respect to the longitudinal direction of advancement 108 and which connects the end of the return conveyor track 114 to the beginning of the longitudinal conveyor track 110.

The second transverse conveyor track 130 comprises two transverse conveyor rails 134, which run in parallel with the second transverse direction of advancement 132 and form a third rail crossing 136 with the return conveyor rails 118 of the return conveyor track 114 and a fourth rail crossing 138 with the longitudinal conveyor rails 112 of the longitudinal conveyor track 110.

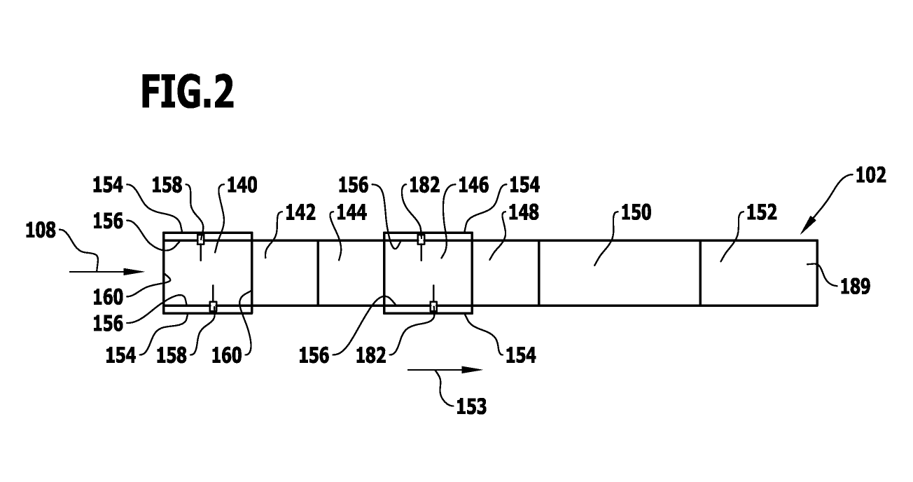

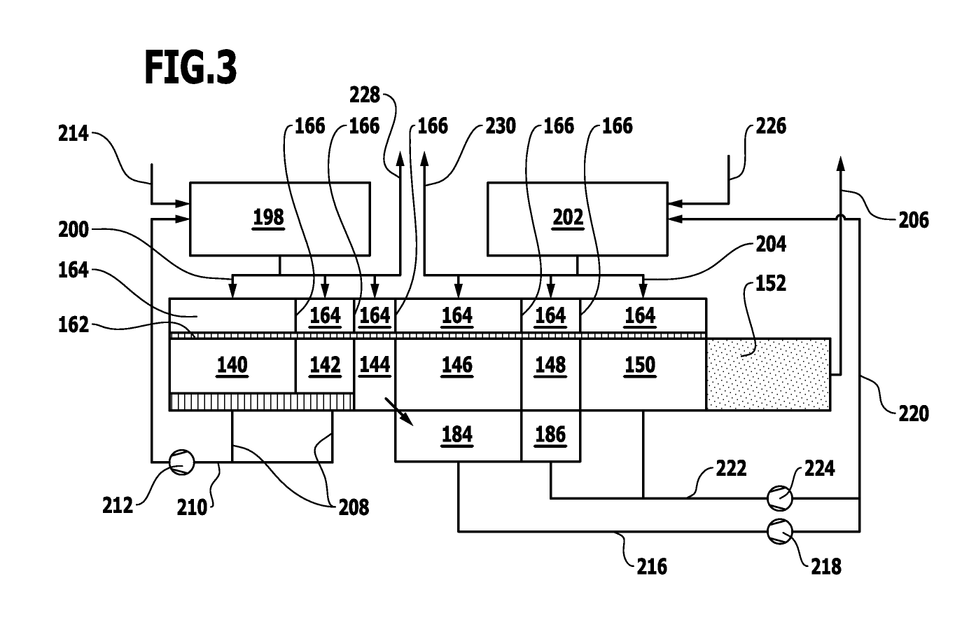

The processing booth 102 of the coating plant 100 is illustrated in greater detail in FIGS. 2 and 3.

The processing booth 102 comprises a fully automatic pre-treatment zone 140, a first reserve zone or back-up zone 142 for carrying out a manual pre-treatment, an air-lock zone 144, a fully automatic coating zone 146, a second reserve zone or back-up zone 148 for carrying out a manual coating process, an evaporation zone 150 and a drying zone 152.

The aforesaid zones follow one another in the said sequence in a longitudinal direction 153 of the processing booth 102 which corresponds to the longitudinal direction of advancement 108.

The pre-treatment zone 140 is in the form of a closed booth which is composed of self-supporting framework elements consisting of sheet steel sections having glass infill panels and sheet metal infill panels integrated into the elements of the framework.

The side walls 154 of the pre-treatment zone 140 that are formed from these framework elements comprise, in the sequence from top to bottom, an upper sheet metal panel, an upper glass panel for the arrangement of lights (having a height of approximately 1 m for example), a central sheet metal panel, a lower glass panel (having a height of approximately 1.6 m for example) and a lower sheet metal panel.

The glass infill panels of the side walls 154 preferably consist of single pane safety glass.

The glass infill panels and the sheet metal infill panels are screwed or clamped into seals in such a way that cleaning media used for cleansing the booth cannot penetrate outwardly therethrough and such that the infill panels are prevented from falling out in the event of fire.

The lights envisaged for the upper glass panels of the side walls 154 comprise asymmetrical reflectors and sheet metal housings which are pressed onto the glass panels externally.

The lighting housings can be provided with adjustable fixing devices and clamping devices, with safety chains or a suspension device as well as a seal against the glass sheet.

The lighting for the booth is controllable locally by means of a lighting cabinet.

A drive rail 156 extending in parallel with the longitudinal direction of advancement 108 for an automatic pre-treatment unit 158 that is movable in parallel with the longitudinal direction of advancement 108 is arranged on the lower sheet metal panel.

The automatic pre-treatment unit 158 may, in particular, be in the form of a pre-treatment robot.

The side walls 154 are thus readied for the integration of the pre-treatment units 158.

Doors are provided in the side walls 154 so that maintenance or cleaning personnel can enter the interior of the booth.

The doors may be in the form of steel doors incorporating viewing windows for example.

For the purposes of operating the doors, push plates are preferably attached thereto on the inside of the booth and handles are provided on the exterior thereof.

The doors preferably open outwardly.

At the beginning and at the end of the booth, there is a respective end wall 160 of panel-like construction which is then ready for the attachment of further parts of the plant and in particular, further booths.

The end wall 160 may be in the form of a zinc coated metal sheet for example.

The end wall 160 is preferably smooth and is constructed as a double-walled structure and is thus ready for concealed cable runs.

In order to enable the workpiece 106 to be advanced from one booth to the next-following booth, the end wall 160 is provided with a passage opening which preferably has a rigid outline.

When the workpiece 106 is passing therethrough, the distance from the outline to the surface of the workpiece preferably amounts to at least 0.5 m.

In order to detect misalignment of the workpiece 106 when passing through the passage opening and enable the coating plant 100 to be switched off in such a case, there are provided in the passage opening, hanging screens which are deflected from their rest position if an improperly oriented workpiece 106 comes into contact with them. The deflection of such a hanging screen is registered by a proximity switch associated with the hanging screen whereupon it sends a signal to the control centre of the coating plant 100 which leads to an emergency shutdown of the coating plant 100.

The proximity switches of the hanging screens are preferably integrated into the respective end wall 160.

The bottom of the booth is in the form of self-supporting structural steelwork incorporating removable gratings.

A drip tray made of high-grade steel, preferably non-sloping, is installed under the gratings.

The entrance doors to the booth are at the level of the gratings or are accessible from the level of the grating via platforms, preferably smooth sheet metal platforms, by means of a staircase.

The work space of the booth is closed in the upward direction by a ceiling filter 162 (see FIG. 3).

The ceiling filter can be formed from galvanized and/or lacquered sheet metal elements having an integrated lacquered wire grating.

The framework of the ceiling filter 162 is preferably configured as a walkway.

The amount by which the filter of the ceiling filter 162 is contaminated is monitorable by a differential pressure manometer.

The differential pressure manometer preferably has a display which is readable locally in the booth.

The differential pressure across the ceiling filter 162 is determined in a zone of the booth representative of the filter contamination.

A filter plenum 164 is located above the ceiling filter 162, whereby the filter plenums of the successive booths in the longitudinal direction of advancement 108 are likewise separated from each other by partition walls 166 so as to allow air to be supplied separately to the zones of the processing booth 102 in sectionalised manner in accord with the work zone.

The filter plenum 164 is provided with a lighting system which is capable of being switched on preferably from a central position of the filter plenum 164 by means of a switch incorporating a pilot lamp.

The filter plenum 164 is accessible through an air-tight maintenance door by maintenance or cleaning personnel.

The booth of the pre-treatment zone 140 is ventilated by means of an air re-circulating system; the ventilation of the booth will be described in detail hereinafter with reference to FIG. 3.

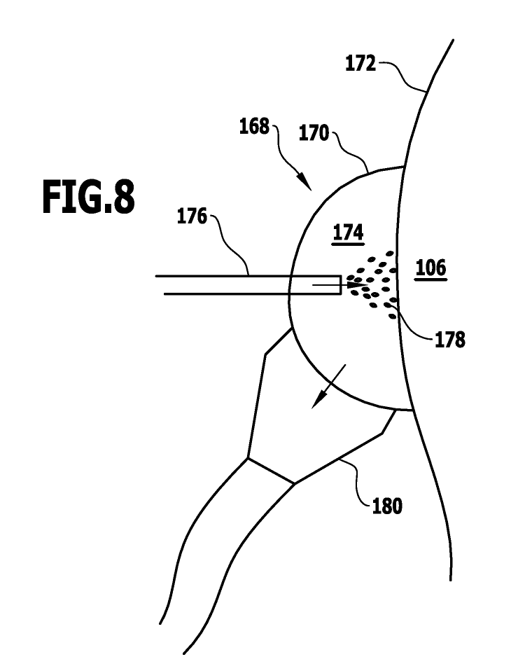

For the purposes of pre-treating the workpiece 106, each of the movable automatic pre-treatment units 158 is provided with a vacuum suction-jet device 168 that is illustrated schematically in FIG. 8.

The vacuum suction-jet device 168 comprises a jet hood 170 which is open towards the workpiece 106 and is positionable on the surface 172 of the workpiece 106 in substantially air-tight manner by means of a seal which is arranged on the rim of the jet hood 170 facing the workpiece 106.

A blasting lance 176, by means of which an abrasive medium 178 is appliable to the surface 172 of the workpiece 106 bounding the interior space 174, opens up into the interior space 174 of the jet hood 170.

The surface 172 that is to be coated is activated by the impact of the abrasive medium 178 on the surface 172 of the workpiece 106.

The abrasive medium is sucked out of the interior space 174 of the jet hood 170 through an exhaust pipe 180.

The exhaust pipe 180 is attached to a source of negative pressure so that a negative pressure is produced in the interior space 174 of the jet hood 170 whereby the jet hood 170 is pressed against the surface 172 of the workpiece 106.

In order to cover the entire surface 172 of the workpiece 106 that is to be coated, the jet hoods 170 are moved over the entire surface 172 of the workpiece 106 that is to be coated by means of the pre-treatment units 158 in the form of movable robots that are respectively associated therewith.

Due to the fact that the abrasive medium 178 and the respective part of the surface 172 of the workpiece 106 to which it is applied are separated from the environment by the jet hood 170, there is no accumulation of dust in the pre-treatment zone 140 during the process of activation by means of the vacuum suction-jet device 168.

As an alternative to a vacuum suction-jet device 168, a robot-guided brushing system incorporating a suction device could also be employed for the purposes of activating the surface 172 of the workpiece 106 that is to be coated.

The first back-up zone 142 following the pre-treatment zone 140 in the longitudinal direction of advancement 108 is in the form of a closed booth in like manner to the pre-treatment zone 140, and the construction thereof corresponds to that of the booth of the pre-treatment zone 140 so that to this extent, reference should be made to the preceding description thereof.

The first back-up zone 142 is not however provided with automatic pre-treatment units 158. Rathermore, the first back-up zone 142 serves for permitting the pre-treatment of the workpiece 106 to be carried out manually by workers 181 (see FIG. 4) using suitable pre-treatment equipment in the event of breakdown or if the result of the work effected by the automatic pre-treatment units 158 in the pre-treatment zone 140 is unsatisfactory.

The air-lock zone 144 follows the first back-up zone 142 in the longitudinal direction of advancement 108, a vertically acting air curtain being producible in the air-lock zone 144 in order to separate the atmosphere in the pre-treatment zone 140 and the first back-up zone 142 from that in the coating zone 146 which follows onto the air-lock zone 144 and thereby prevent impurities from the pre-treatment zone 140 or the first back-up zone 142 from reaching the coating zone 146 or else coating material from the coating zone 146 reaching the pre-treatment zone 140 or the first back-up zone 142.

In like manner to the pre-treatment zone 140, the coating zone 146 following the air-lock zone 144 in the longitudinal direction of advancement 108 is in the form of a closed booth, the structure thereof upwardly of the level of the grating being identical to the structure of the booth of the pre-treatment zone 140 so that to this extent, reference should be made to the preceding description thereof.

However, instead of the pre-treatment units 158, coating units 182 are used in the coating zone 146, said coating units being movable in parallel with the longitudinal direction of advancement 108 on the drive rails 156 which are integrated into the side walls 154 of the booth.

The coating units 182 can be in the form of coating robots, in particular in the form of 7-axes robots for example.

The coating units 182 are provided with suitable application devices for the application of coating material to the surface 172 of the workpiece 106.

In particular, a lacquer, preferably a solvent-free lacquer and especially a water lacquer can be used as the coating material.

Optionally, in addition to the coating units 182 which are located on the two long sides of the coating zone 146, further coating units can be arranged at the ends of the zone over the inlet to the coating zone 146 and/or over the outlet from the coating zone 146.

Due to the mobility thereof, the coating units 182 enable the coating material, and in particular the lacquer, to be applied continuously to the workpiece 106.

A separating device 184 (see FIG. 3) is provided under the coating zone 146 for separating out excess coating material from an air stream flowing downwardly through the coating zone 146.

The separating device 184 is preferably in the form of a dry separation device and comprises filter elements that are coated with pre-coat material, upon the pre-coat layer of which settle sticky particles from the coating material.

Stone dust for example can be used as a pre-coat material.

A supply of the pre-coat material is kept in a (for example funnel-shaped) storage vessel located below the filter elements and this is whirled up by means of air jets at intervals in order to coat the filter elements with fresh pre-coat material.

If the pre-coat layer consisting of the pre-coat material on a filter element is saturated with coating material by more than a given amount, this pre-coat layer which is saturated with the coating material is loosened from the filter element by a burst of compressed air from the clean gas side of the filter element whereupon the mixture consisting of the pre-coat material and the coating material falls into the storage vessel and is then sucked out from there.

Such a dry separation device is known from DE 10 2007 040 901 A1 for example, to which reference should be made in regard to the construction and functioning of such a dry separation device and which is hereby incorporated in this application in these respects.

Such a dry separation device, which is arranged below the grating level of the coating zone 146, may comprise, in particular, a casing for the filter elements on both sides of the vertical longitudinal centre plane of the booth, which is aligned in parallel with the longitudinal direction of advancement 108, as well as filter modules which contain the filter elements, an accessible gangway arranged between the filter housings, a supply unit for the supply of fresh pre-coat material to the storage vessels located below the filter elements and an extraction unit for the removal of the mixture consisting of pre-coat material and coating material from the storage vessels.

As an alternative or in addition to the dry separation device incorporating pre-coated filter elements described above, there could also be used a dry separation device which comprises cardboard labyrinth filters upon which the coating material from the air stream that is loaded with coating material is deposited.

Moreover, instead of a dry separation device, it is also possible to use a wet washing out device as the separating device 184.

In like manner to the coating zone 146, the second back-up zone 148 following the coating zone 146 in the longitudinal direction of advancement 108 is in the form of a closed booth, the structure thereof upwardly of the grating level being identical to the structure of the booth of the coating zone 146 so that to this extent, reference should be made to the preceding description thereof.

The second back-up zone 148 does not however comprise automatic coating units 182. Rathermore, the second back-up zone 148 serves for permitting the coating of the workpiece 106 to be carried out manually by workers 181 (see FIG. 4) using suitable coating equipment in the event of breakdown or if the result of the work effected by the coating units 182 in the automatic coating zone 146 is unsatisfactory.

Below the second back-up zone 148, there is provided a separating device 186 for separating out excess coating material from a stream of air flowing downwardly through the second back-up zone 148 from above in like manner to the coating zone 146.

Since, however, only a brief emergency coating action is intended to be carried out in the second back-up zone 148, the performance of this separating device 186 can be designed for a lesser degree of separation.

Consequently, it will in general be sufficient for the separating device 186 to be in the form of a dry separation device using a cardboard labyrinth system.

Such a cardboard labyrinth system for example comprises extraction ducts which are arranged below the level of the grating and are equipped with vertically arranged, hinged supporting frames for coating-media separators. The separation of the coating material is effected by glass fibre fleece filters and downstream cardboard labyrinth filters.

The evaporation zone 150 following the second back-up zone 148 in the longitudinal direction of advancement 108 is in the form of a closed booth in like manner to the previously described zones and preferably comprises a housing of galvanized steel sheet which is provided with an interior lighting system and a closely fitting door.

An air supply duct incorporating filter frames that are replaceable from below is provided in the ceiling region of the evaporation zone 150.

The process of exhausting the air that has been supplied the evaporation zone 150 is effected in the floor region of the evaporation zone 150.

The drying zone 152 following the evaporation zone 150 in the longitudinal direction of advancement 108 is in the form of a closed booth in like manner to the previously described zones and it is preferably installed in the manner of a self-supporting structure consisting of prefabricated housing segments.

The entire internal contour of the drying zone 152 is preferably implemented in a cleaning-friendly and maintenance-friendly manner.

In order to prevent fluff from settling in the drying zone 152 during a cleaning operation, all the edges of the sheets and the welding seams in the working area of the drying zone 152 are preferably deburred and the dryer tunnel is preferably implemented as a smooth structure.

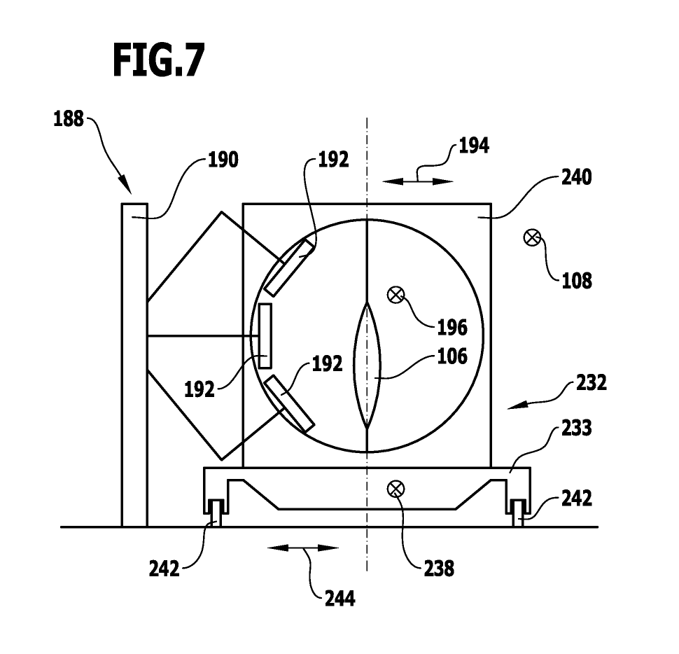

In the drying zone 152, irradiation units 188, of which one is illustrated in detail in FIG. 7, are arranged on both sides of the conveyance path of the workpiece 106.

The irradiation unit 188 comprises a pedestal or a stand 190 upon which a plurality of, for example three, irradiation devices 192 are held.

Radiation is appliable to the coated surface 172 of the workpiece 106 by means of the irradiation devices 192 so as to dry and/or harden the coating.

This radiation may for example be infrared radiation and/or UV radiation (in the event of the coating being one that is curable by a UV irradiation process).

The drying zone 152 together with the irradiation units 188 contained therein thus forms a drying device 189 relative to which the workpiece 106 is moved, whilst the workpiece 106 is being coated and whilst the workpiece 106 is being dried.

The irradiation devices 192 are adjustable, preferably independently, in regard to the vertical position thereof and in regard to the position thereof in the transverse direction 194 of the drying zone 152 (preferably by motorised, hydraulic or pneumatic means) in order to automatically set a desired spacing between the respective irradiation device 192 and the part of the surface 172 of the workpiece 106 that is currently being irradiated.

Since the cross section of the workpiece 106 varies in the longitudinal direction 196 thereof, the irradiation devices 192 are thus moved towards the workpiece 106 or away from the workpiece 106 whilst the workpiece 106 is passing by.

The effect is thereby achieved that the average amount of radiation falling on the coated surface 172 of the workpiece 106 remains substantially constant despite the varying cross section of the workpiece 106 since the position of the irradiation devices 192 is automatically adapted to the geometry of the workpiece 106.

Furthermore, it is possible to switch-out or switch-in individual irradiation devices 192 and/or to alter the power output of the irradiation devices 192 in order to produce the desired quantity of radiation falling on the workpiece surface.

In order to produce a uniform surface temperature over the surface of the workpiece 106, the temperature of the workpiece surface is detected and the radiant power emitted by each of the irradiation devices 192 is regulated, as is also the distance of the irradiation devices 192 from the surface 172 of the workpiece 106, in dependence upon the result of the temperature detection process.

Detection of the temperature can be effected in particular by means of a pyrometer. Such a pyrometer detects the radiant heat emitted by an object in non-contact-making manner and evaluates it in order to determine the temperature of the object, whereby use is made of the fact that the intensity of the radiant heat emitted by an object depends on its temperature.

The irradiation devices 192 are coolable by means of cooling air which is blown over the surfaces of the irradiation devices 192 that are to be cooled by means of flexible hoses.

Following this description of the individual zones of the processing booth 102, the system for supplying air through the processing booth 102 will now be described with reference to the air supply diagram depicted in FIG. 3:

The coating plant 100 comprises a first air re-circulating unit 198 which supplies the pre-processing zone 140, the first back-up zone 142 and the air-lock zone 144 with air via the air supply lines 200, and a second air re-circulating unit 202 which supplies the coating zone 146, the second back-up zone 148 and the evaporation zone 150 with air via the air supply lines 204.

The drying zone 152 receives its air supply indirectly from the evaporation zone 150; exhaust air from the drying zone 152 is exhausted from the drying zone 152 through an exhaust air duct 206 and fed off into the surroundings.

The booth air that is supplied to the pre-treatment zone 140 and the first back-up zone 142 via the respective filter plenum 164 and the respective ceiling filter 162 is sucked out of the booths through excess-air openings that are arranged in the floor region of the respective side walls 154 for example, and is then fed back into the first air re-circulating unit 198 by way of exhaust air ducts 208 which flow into a main exhaust air duct 210.

The excess-air openings through which air is sucked out of the booths can be equipped with hinged supporting frames.

Fibre filters consisting of glass fibre fleece for example, can be clamped into these supporting frames.

A fan 212 which sucks in the exhaust air from the pre-processing zone 140 and the first back-up zone 142 and supplies it to the first air re-circulating unit 198 is arranged in the main exhaust air duct 210, whereby the air re-circulating system is closed by the first air re-circulating unit 198 and the pre-treatment zone 140 or the first back-up zone 142.

In the first air re-circulating unit 198, the circulating air is modified to meet the desired air conditions by conditioning devices (a heating device, a cooling device, a humidifying device and/or a dehumidifying device for example) and supplemented if necessary with fresh air which is supplied to the first air re-circulating unit 198 by way of a fresh air supply line 214.

The energy necessary for the conditioning of the booth atmosphere (for the heating, cooling, humidifying and/or dehumidifying processes) is kept to a minimum due to the air circulation system.

The ventilation of the coating zone 146, the second back-up zone 148 and the evaporation zone 150 is likewise effected by means of the air circulation system.

In connection therewith, the exhaust air from the coating zone 146 that has been released from excess coating material in the separating device 184 is sucked through an exhaust air duct 216 into a main exhaust air duct 220 by means of the fan 218 and supplied from there to the second air re-circulating unit 202.

The exhaust air from the second back-up zone 148 which has possibly been released from excess coating material in the separating device 186 and the exhaust air from the evaporation zone 150 which has been sucked from the floor region of the evaporation zone 150 are sucked through an exhaust air duct 222 by means of the fan 224 into the main exhaust air duct 220 and likewise supplied from there to the second air re-circulating unit 202.

The air circulating system is thus closed by the second air re-circulating unit 202 and the coating zone 146, the second back-up zone 148 or the evaporation zone 150.

In the second air re-circulating unit 202 too, the circulating air is modified to meet the desired air conditions by conditioning devices (a heating device, a cooling device, a humidifying device and/or a dehumidifying device for example) and supplemented if necessary with fresh air which is supplied to the second air re-circulating unit 202 by way of a fresh air supply line 226.

Due to the air circulation system for the coating zone 146, the second back-up zone 148 and the evaporation zone 150, the energy necessary for the air conditioning process (in particular, for the heating, cooling, humidifying and/or dehumidifying processes) is further reduced.

By allocating the zones of the processing booth 102 to two different air re-circulating units 198 and 202, the atmosphere in the booths can be conditioned in different ways as required, and in particular, it can be conditioned in a different manner for the pre-treatment zone 140 on the one hand and for the coating zone 146 on the other.

Due to the fact that the air supply for each booth is supplied by way of its own air supply line 200 and 204, the quantity of air supplied to each booth can be precisely matched to the respective needs thereof. As a result of this sectionalised air supply system (selective ventilation of the individual zones of the processing booth 102), a further saving of energy is obtained.

The air-lock zone 144 represents a connecting link between the two air re-circulating systems of the coating plant 100 since, although it does receive its air supply from the first air re-circulating unit 198, the exhaust air from this air-lock zone 144, which may be loaded with excess coating material from the coating zone 146, cannot be fed back to the first air re-circulating unit 198, but rather, it is supplied to the second air re-circulating unit 202 by way of the separating device 184. Nevertheless, the air supply to the air-lock zone 144 is always supplied thereto via an air circulation system, this thereby entailing a saving of energy.

Surplus air from the air circulation system of the first air re-circulating unit 198 is delivered to the environment through an outgoing air line 228 which is attached to the air supply lines 200 of the first air circulation system.

Surplus air from the air circulation system of the second air re-circulating unit 202 is delivered to the environment through an outgoing air line 230 which is attached to the air supply lines 204 of the second air circulation system.

The transportation of the workpiece 106 that is to be coated through the processing booth 102 is effected by means of a workpiece carriage 232 which is illustrated in FIGS. 4 to 7.

The workpiece carriage 232 comprises a substantially rectangular framework 233 consisting of two box shaped side members 234 which are connected to one another by transverse beams 236 running perpendicularly to the longitudinal direction 238 of the workpiece carriage 232.

The space remaining between the transverse beams 236 following each other in the longitudinal direction 238 is sufficient for allowing the air flow for the booth to pass through the workpiece carriage 232 in the vertical direction.

At the front ends thereof, the two side members 134 together carry a workpiece holder 240.

The workpiece 106 that is to be coated, a rotor blade for a wind turbine for example, is fixed at one end to the workpiece holder 240, by a bolting or clamping arrangement for example.

Hereby, the workpiece 106 is arranged on the workpiece carriage 232 in such a way that the longitudinal direction 196 of the workpiece 106 substantially corresponds to the longitudinal direction 238 of the workpiece carriage 232.

As can be seen from FIGS. 4 and 5, the longitudinal extent L of the workpiece 106 in the common longitudinal direction is significantly greater than the longitudinal extent I of the workpiece carriage 232.

The workpiece 106 thus projects for a considerable length beyond the rear end of the workpiece carriage 232.

In particular, provision may be made for the protrusion of the workpiece 106 beyond the workpiece carriage 232 to amount to at least half, and preferably, to at least two thirds of the longitudinal extent L of the workpiece 106 in the longitudinal direction 196 thereof.

For the purposes of forward movement in the longitudinal direction of advancement 108 and as can best be seen from FIG. 5, each side member 234 of the workpiece carriage 232 has two longitudinal running wheels 242 which are rotatable about axes running in parallel with the transverse direction 244 of the workpiece carriage 232.

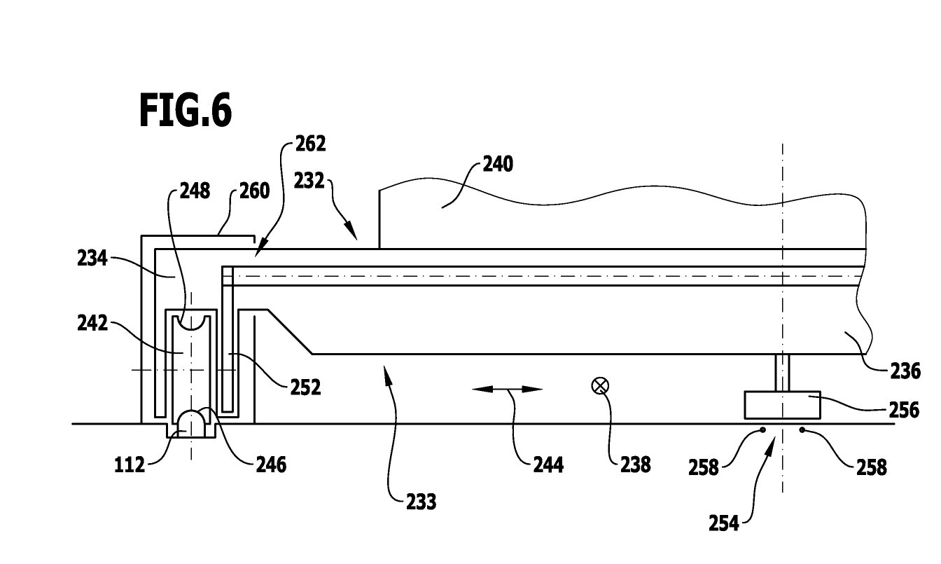

Since the workpiece carriage 232 must run very smoothly in order to ensure that an even coating is obtained, the longitudinal conveyor rails 112, upon which the longitudinal running wheels 242 are rolling, are in the form of round rails having a convexly curved bearing surface 246 (see FIG. 6).

In preferred manner, the longitudinal running wheels 242 are made from a hardened steel, an aluminium alloy or from a thermosetting synthetic material and the peripheries of their concavely curved running surfaces 248 are complementary to the convexly curved bearing surfaces 246 of the longitudinal conveyor rails 112.

Due to the smooth surfaces of the longitudinal conveyor rails 112 and the longitudinal running wheels 242 that are ground in complementary manner thereto, very smooth running of the workpiece carriage 232 in the longitudinal direction of advancement 108 is achieved.

In alternative exemplary embodiments, the longitudinal running wheels are equipped with solid rubber tyres or with gas-filled tyres.

The diameter of the longitudinal conveyor rails 112 can amount to approximately 60 mm for example and the diameters of the longitudinal running wheels 242 to approximately 250 mm.

The return conveyor rails 118 of the return conveyor track 114 are constructed in like manner to the longitudinal conveyor rails 112 of the longitudinal conveyor track 110.

For the transverse transportation of the workpiece carriage 232 from the longitudinal conveyor track 110 to the return conveyor track 114 or from the return conveyor track 114 to the longitudinal conveyor track 110, a respective transverse running wheel 250 is arranged on each end face of each side member 234 of the workpiece carriage 232 (see FIG. 5).

The transverse running wheels 250 are held on the framework of the workpiece carriage 232 in height adjustable manner and the height thereof relative to the framework 233 and thus relative to the longitudinal running wheels 242 can be adjusted (by means of a motor or hydraulically for example). In all other respects, the details of the transverse running wheels can be similar (or identical) to that of the longitudinal running wheels.

During the movement of the workpiece carriage 232 in the longitudinal direction of advancement 108 or in the reverse direction of advancement 116, the transverse running wheels 250 are located in their upper position in which the transverse running wheels 250 are lifted off the underlying ground so that the workpiece carriage 232 is supported on the longitudinal conveyor rails 112 or on the return conveyor rails 118 by means of the longitudinal running wheels 242.

When the workpiece carriage 232 reaches the vicinity of the first rail crossing 126 or the third rail crossing 136, the transverse running wheels 250 on the end faces are lowered until the workpiece carriage 232 is supported on the transverse conveyor rails 124 or 134 by means of the transverse running wheels 250 and the longitudinal running wheels 242 are raised up from the longitudinal conveyor rails 112 or the return conveyor rails 118. In this position of the transverse running wheels 250, the workpiece carriage 232 is free for the transverse transportation process in the first transverse direction of advancement 122 or in the second transverse direction of advancement 132.

In principle, the transverse conveyor rails 124 and 134 could also be provided with a convexly curved bearing surface in like manner to the longitudinal conveyor rails 112 and the transverse running wheels 250 could be provided with a concavely curved running surface.

However, the demands made on a smooth running process for the transverse transportation of the workpiece 106 outside the processing booth 102 are less stringent so that the transverse conveyor rails 124 and 132 can be in the form of flat rails having a substantially flat bearing surface and the transverse running wheels 250 can be provided with cylindrical running surfaces.

The use of transverse running wheels 250 having cylindrical running surfaces has the advantage that they can be narrower than running wheels having concavely curved running surfaces and therefore only need a smaller amount of space in order to achieve the necessary wheel load.

The diameter of the transverse running wheels 250 can amount to approximately 400 mm for example.

The workpiece carriage 232 is preferably self-propelled.

Preferably, at least two longitudinal running wheels 242 and at least two transverse running wheels 250 per carriage are motor driven. It is particularly preferred hereby that all of the longitudinal running wheels 242 and all of the transverse running wheels 250 be driven.

The drive devices needed for this purpose are preferably accommodated in the interior space of the box shaped side members 234 of the workpiece carriage 232 so that the free cross section of the workpiece carriage 232 available for the through-flow of air through the booth in the vertical direction will remain as large as possible.

The transmission of the drive movement from the drive device to the respectively driven running wheel can be effected by means of a drive belt 252 (see FIG. 6), and in particular, a toothed belt for example.

The drive devices for the running wheels preferably comprise at least one electric motor. Optionally however, each driven wheel may have an individually associated gearless electric motor.

The electrical energy needed for the supply of the electric motor is preferably transmitted in non-contact-making manner by electrical induction from a conductor system 254 laid between the conveyor rails of a conveyor track to a pickup coil 256 on the workpiece carriages 232 (see FIG. 6).

In order for this inductive process of transmitting energy to be possible, the environment of the pickup coil 256 and the conductor system 254 must be iron-free.

This necessarily iron-free space is achieved in all the zones of the processing booth 102 by raising the level of the grating by at least approximately 20 cm for example, above the floor level in the vicinity of the conductor system 254. The pickup coil 256 is led below the level of the grating.

The pickup coil 256 is held on the framework 233 of the workpiece carriage 232 in height adjustable manner (by means of a motor or hydraulically for example) so that the pickup coil 256 can be lowered relative to the framework 233 during the transition from the longitudinal transportation mode to the transverse transportation mode in order to maintain the same distance from the conductor system 254 as that during the longitudinal transportation process.

The conductors 258 of the conductor system 254 are fed through plastic tubes within the processing booth 102 and can be supported on cross beams of the processing booth 102 by means of plastic blocks for example.

When using a non-contact-making system for the transmission of energy to the workpiece carriage 232, it is preferred that use be made of a solvent-free coating material, in particular a solvent-free lacquer.

A high frequency panel having a frequency of 25 kHz for example is preferably used for the non-contact-making, and in particular inductive, transmission of energy.

Instead of utilising a non-contact-making system for the transmission of energy to the workpiece carriages 232, provision could also be made for the workpiece carriage 232 to be provided with a storage means for electrical energy, in particular with an accumulator. The drive elements required for this variant of a drive means are available in an explosion-proof form.

In the particular case where a plurality of workpiece carriages 232 are being used in the coating plant 200, at least three of them for example, then there is adequate time available for charging the accumulator during the return of a workpiece carriage 232 along the return track 114.

In order to prevent the longitudinal conveyor rails in the processing booth 102 from becoming contaminated, the longitudinal conveyor rails 112 and the side members 234 of the workpiece carriage 232 equipped with the longitudinal running wheels 242 are separated at least in the coating zone 146 and the second back-up zone 148 by a casing 260, which can be in the form of a sheet metal cladding for example, from the application area in which the coating material is applied to the workpiece 106 so that the longitudinal conveyor rails 112 and the longitudinal running wheels 242 are protected from contamination by the coating material overspray and also from contact with the exhaust air stream from the booth which is loaded with excess coating material. As can be seen from FIG. 6, the casing 260 only has a narrow passage gap 262 through which the cross beams 236 of the workpiece carriage 232 extend from the application area outside the casing 260 into the protected interior of the casing 260. Thereby, only a small gap remains between the workpiece carriage 232 and the edges of the passage gap 262 so that substantially no coating material can get through this narrow gap into the interior of the casing 260.

The longitudinal conveyor rails 112, the longitudinal running wheels 242 and the side members 234 of the workpiece carriage 232 are accommodated in their entirety in the protective casing 260.

The previously described coating plant 100 is suitable, in particular, for the coating of very long workpieces, and especially elongated workpieces having a longitudinal extent L which is significantly greater than the maximum extent B in a transverse direction running perpendicular to the longitudinal direction 196 (see FIG. 5).

Preferably, the longitudinal extent L of the workpiece 106 is at least five times greater than the maximum transverse extent B.

In particular, the coating plant 100 is suitable for the coating of workpieces having a length of at least 10 m, preferably of at least 30 m, of approximately 50 m for example.

A suitable workpiece 106 may be in the form of the rotor blade of a wind turbine for example.

A method for providing a workpiece with a coating is carried out using the previously described coating plant 100 as follows:

The workpiece 106 that is to be coated is fixed to the workpiece holder 240 of the workpiece carriage 232 in such a manner that the longitudinal direction 196 of the workpiece 106, i.e. the direction of the largest longitudinal extent of the workpiece 106, substantially corresponds to the longitudinal direction 238 of the workpiece carriage 232 and the longitudinal direction of advancement 108 in the coating plant 100.

The workpiece carriage 232 together with the workpiece 106 held thereon, which is supported by the longitudinal running wheels 242 on the longitudinal conveyor rails 112 of the longitudinal conveyor track 110, is then set in motion from the region of the first rail crossing 126 so that it enters the pre-treatment zone 140 of the processing booth 102 and successively passes through all the other zones of the processing booth 102.

The conveying speed of the workpiece carriage 232 preferably amounts to 1 m/min or less, as long as the workpiece 106 is being treated within the processing booth 102.

During the treatment of the workpiece 106, the conveying speed preferably amounts to approximately 0.8 m/min.

As soon as the workpiece 106 has completely left the processing booth 102, the conveying speed, in particular along the return conveyor track 114, can be increased to a conveying speed of more than 1 m/min, for example, to approximately 12 m/min.

The workpiece carriage 232 can move through the processing booth 102 at variable speeds, and in particular can be temporarily stopped and started again. Preferably however, the workpiece carriage 232 moves through the processing booth 102 in a continuous manner, preferably at a substantially constant speed.

Whilst the workpiece 106 is passing through the successive zones of the processing booth 102 in this way, each section of the surface 172 of the workpiece 106 is treated successively in these zones in the respectively scheduled manner.

The part of the surface 172 of the workpiece 106 currently in the pre-treatment zone 140 is activated by means of the movable pre-treatment units 158 whilst this part of the workpiece 106 is moving through the pre-treatment zone 140.

That part of the surface 172 of the workpiece 106 that is currently located in the coating zone 146 is provided with the coating material by means of the movable coating units 182 whilst the relevant part of the workpiece 106 is moving through the coating zone 146.

Volatile components of the coating material evaporate off that part of the surface 172 of the workpiece 106 that is currently located in the evaporation zone 150, whilst the relevant part of the workpiece 106 is moving through the evaporation zone 150.

The part of the surface 172 of the workpiece 106 that is in each case located in the drying zone 152 is dried and/or hardened by means of the irradiation units 188, whilst the relevant part of the workpiece 106 is moving through the drying zone 152.

As can best be seen from FIG. 4, the longitudinal extent L of the workpiece 106 is significantly greater than the longitudinal extent of the pre-treatment zone 140, the coating zone 146, the evaporation zone 150 and the drying zone 152.

In particular, the longitudinal extent of the workpiece 106 is so large that different parts of the surface 172 of the workpiece 106 are being treated in different manners, at least occasionally, at the same time in different zones of the processing booth 102.

Thus, the front end of the workpiece 106 (for example the rotor blade root of the rotor blade for a wind turbine) is already in the evaporation zone 150 whilst, at the same time, a middle section of the workpiece 106 is being coated in the coating zone 146 and the rear end of the workpiece 106 (for example the tip of the rotor blade) is being simultaneously activated in the pre-treatment zone 140.

As a result of this simultaneity of the processes being performed on the workpiece 106, the entire processing time for the workpiece 106 in the processing booth 102, i.e. the time required for the workpiece 106 to pass through the processing booth 102, is significantly reduced.

Due to the continuous running principle being used, the individual processing zones of the processing booth 102 can be significantly shorter than the workpiece 106 that is to be processed therein.

Thus, in the case of an exemplary longitudinal extent L of the workpiece 106 of approximately 50 m, the pre-treatment zone 140 has a longitudinal extent in the longitudinal direction of advancement 108 of approximately 6 m, the first back-up zone 142 a longitudinal extent of approximately 3 m, the air-lock zone 144 a longitudinal extent of approximately 3 m, the coating zone 146 a longitudinal extent of approximately 6 m, the second back-up zone 148 a longitudinal extent of approximately 3 m, the evaporation zone 150 a longitudinal extent of approximately 24 m and the drying zone 152 a longitudinal extent of approximately 10 m.

As a result of the smaller booth size of the individual zones and the sectionalised supply of air as well as the air circulating system that is used in most zones of the processing booth 102, a significant saving of energy is obtained.

The coating plant 100 does not have to be dimensioned in dependence upon the size of the workpiece, but can be designed in dependence upon the desired throughput.

When the workpiece 106 has passed through the processing booth 102 in its entirety, the rear end of the workpiece 106 has left the drying zone 152 and the workpiece carriage 232 has reached the first rail crossing 126, the workpiece carriage 232 is changed from the longitudinal transportation mode to the transverse transportation mode by lowering the transverse running wheels 250.

Subsequently, the transverse running wheels 250 of the workpiece carriage 232 are driven in order to move the workpiece carriage 232 in the first transverse direction of advancement 122 from the longitudinal conveyor track 110 to the return conveyor track 114.

After reaching the second rail crossing 128, the workpiece carriage 232 is changed over from the transverse transportation mode to the longitudinal transportation mode by raising the transverse running wheels 250 and the workpiece carriage 232 is moved back along the return conveyor track 114 up to the third rail crossing 136 by driving the longitudinal running wheels 242 in the reverse direction of advancement 116.

After reaching the third rail crossing 136, the workpiece carriage 232 is changed over from the longitudinal transportation mode into the transverse transportation mode by lowering the transverse running wheels 250 and the workpiece carriage 232 is moved along the second transverse conveyor track 130 in the second transverse direction of advancement 132 from the return conveyor track 114 to the longitudinal conveyor track 110 by driving the transverse running wheels 250.

After reaching the fourth rail crossing 138, the workpiece carriage 232 is changed over again from the transverse transportation mode into the longitudinal transportation mode by raising the transverse running wheels 250, and the workpiece carriage 232 together with the workpiece 106 held thereon is moved once more through the processing booth 102 by driving the longitudinal running wheels 242 in order to carry out a second coating process on the workpiece 106.

After its second run through the processing booth 102, the workpiece 106 can be removed from the workpiece carriage 232, for example, when the workpiece carriage 232 has reached the first rail crossing 126.

However, it is also possible for the workpiece carriage 232 together with the workpiece 106 held thereon to be moved back in the previously described manner to the starting point at the fourth rail crossing 138 and for the workpiece 106 to be removed from the workpiece carriage 232 only at this point.

Furthermore, it is also possible for the workpiece 106 to be removed from the workpiece carriage 232 immediately after its first passage through the processing booth 102 if it is only intended that a single coating layer should be applied to the workpiece 106 without an intermediate drying process.

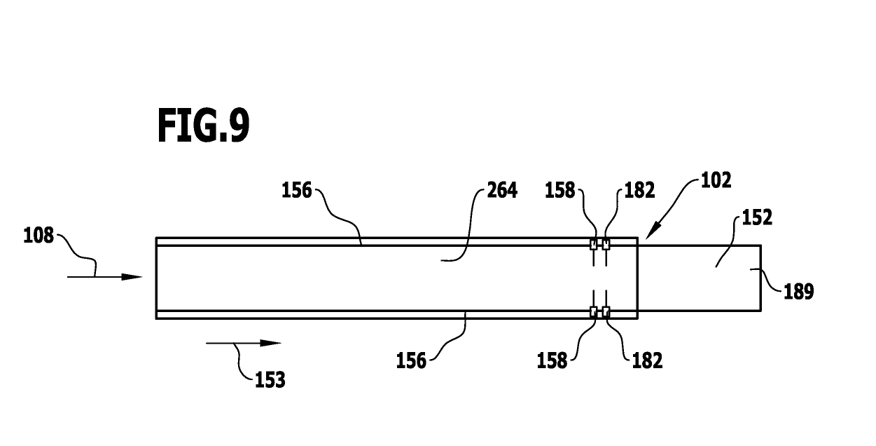

A second embodiment of a coating plant 100 which is illustrated in FIG. 9 differs from the previously described first embodiment which is illustrated in FIGS. 1 to 8 in that the processing booth 102 in this second embodiment has only one work zone 264 before the drying zone 152, wherein the longitudinal extent of said work zone in the longitudinal direction of advancement 108 corresponds at least to the longitudinal extent L of the workpiece 106 so that the workpiece 106 can be driven into the work zone 264 in its entirety.

The work zone 264 serves for pre-treating and for coating the workpiece 106 as well as for carrying out the evaporation process after the coating process.

To this end, the workpiece 106 disposed on the workpiece carriage 232 is driven into the work zone 264 in the longitudinal direction of advancement 108 until the workpiece 106 is completely accommodated in the work zone 264, and then it is brought to a stop.

The basic construction of the work zone 264 corresponds to the construction of the coating zone 146 of the processing booth 102 in the first embodiment of the coating plant 100.

However, in addition to the coating units 182 which are movable on the drive rails 156 running in parallel with the longitudinal direction of advancement 108, the work zone 264 also comprises pre-treatment units 158 which are movable on the same drive rails 156 or on other drive rails that likewise run in parallel with the longitudinal direction of advancement 108.

After the arrival of the workpiece 106 in the work zone 264, the pre-treatment units 158 are driven over the entire length of the workpiece 106 in order to carry out an activation pre-treatment of the entire surface 172 of the workpiece 106. The coating units 182 follow closely upon the pre-treatment units 158 and so conduct in succession a process of completely coating the areas of the surface 172 of the workpiece 106 that were activated just before.

When both the pre-treatment units 158 and the coating units 182 have moved over the entire length of the workpiece 106 (from right to left in FIG. 9 for example), the pre-treatment and the coating of the workpiece 106 are concluded and the workpiece carriage 232 is set in motion in the longitudinal direction of advancement 108 in order to move the completely coated workpiece 106, preferably continuously, through the drying zone 152 which is significantly shorter than the longitudinal extent L of the workpiece 106.

The drying zone 152 thus forms a drying device 189, relative to which the workpiece 106 is moved after the process of coating the workpiece 106 has concluded and whilst the workpiece 106 is being dried.

Within the work zone 264, volatile components of the coating material evaporate off that part of the workpiece 106 which has not yet reached the drying zone 152.

Once the entire workpiece 106 has passed through the drying zone 152 and the entire coating of the workpiece 106 has been dried and/or hardened in the drying zone 152 by irradiation by means of the irradiation units 188, the first coating process of the workpiece 106 is concluded, and the workpiece can be moved back to the entrance of the processing booth 102 in order to carry out a second coating process in the manner described hereinabove in connection with the first embodiment.

This second embodiment of a coating plant 100 has the advantage that the workpiece 106 is not moved during the coating process, this thereby enabling the coating to be applied in a particularly uniform manner.

In contrast to the first embodiment, the significant aspect of this embodiment is that use is made of a long work zone 264 which can accommodate the entire workpiece 106.

Furthermore, very long drive rails 156 for the movable pre-treatment units 158 and for the movable coating units 182 are used so that these units can sweep over the entire surface 172 of the workpiece 106.

In the event that there are no back-up zones, manual emergency action is only possible to a limited extent in the case of this embodiment.

The pre-treatment and the coating processes preferably take place at the same time in the same booth, whereby the air supply for the pre-treatment process and for the coating process is conditioned in an identical manner.

The use of a dry separation device incorporating pre-coated filter elements is envisaged when the length of the work zone 264 that is used for the coating process is less than 10 m.

The conveying speed at which the workpiece 106 is advanced through the drying zone 152 is preferably at least 1 m/min, and is approximately 1.6 m/min for example.

In all other respects, the second embodiment of a coating plant 100 which is illustrated in FIG. 9 corresponds in regard to the construction and functioning thereof to the first embodiment illustrated in FIGS. 1 to 8, and so to this extent, reference should be made to the preceding description thereof.

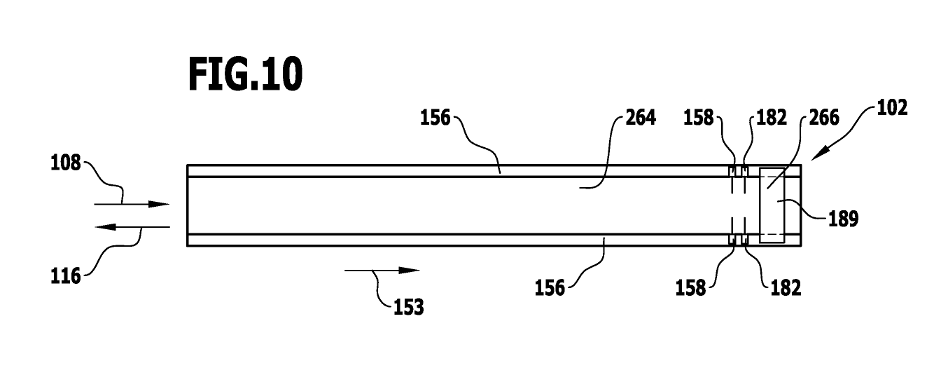

A third embodiment of a coating plant 100 which is illustrated in FIG. 10 differs from the second embodiment illustrated in FIG. 9 in that a dryer portal 266 which is movable in parallel with the longitudinal direction of advancement 112 is arranged in the work zone 264 in the processing booth 102 in this third embodiment, the irradiation devices 192 for the irradiation of the coated surface 172 of the workpiece 106 being held on said dryer portal. In preferred manner, one can therefore dispense with a drying zone 152 adjoined to the work zone 264.

The dryer portal 266 may be movable on the same drive rails 156 as the pre-treatment units 158 and the coating units 182, or separate drive rails for the dryer portal 266 which extend in parallel with the longitudinal direction of advancement 108 can be provided.

In this embodiment, the work zone 264 is significantly longer than the workpiece 106 as there has to be adequate space available for parking the dryer portal 266 between the front end of the workpiece 106 and the rear end wall of the work zone 264.

In this embodiment of a coating plant 100, the workpiece 106 is driven completely into the work zone 264 on the workpiece carriage 232 in the longitudinal direction of advancement 108, and is brought to a stop therein.

Subsequently, the workpiece 106 is pre-treated in its entirety by the pre-treatment units 158 that are being driven in parallel with the longitudinal direction of advancement 108 and is coated by the coating units 182 that are being driven in parallel with the longitudinal direction of advancement 108.

After the coating process comes to an end, the dryer portal 266 is driven in parallel with the longitudinal direction of advancement 108 over the entire length of the workpiece 106, whereby the irradiation devices 192 arranged on the dryer portal 266 irradiate the coated workpiece 106 and thereby dry and/or harden the coating.

The dryer portal 266 thus forms a drying device 189 which is moved relative to the workpiece 106 whilst the workpiece 106 is being dried.

The workpiece 106 can be held immovably in the work zone 264 during the entire process, from the pre-treatment up to the conclusion of the drying process, or it can be driven at a particularly low speed of less than 0.1 m/min.

After the conclusion of the drying process, a second coating process can be carried out in the work zone 264 whilst the workpiece 106 continues to remain motionless, this being followed by a drying process which is effected by moving the dryer portal 266.

After the conclusion of the second coating process including the second drying process, the workpiece 106 is moved out of the work zone 264 on the workpiece carriage 232 in the reverse direction of advancement 116 and is thus moved out of the processing booth 102, and it can then be removed from the workpiece carriage 232.

Since, in this embodiment, a second coating of the workpiece 106 can be effected without the workpiece 106 having to be moved back to the entrance of the processing booth 102 outside the processing booth 102, one can dispense with the return conveyor track 114 and the transverse conveyor tracks 120 and 130 in the case of this embodiment of a coating plant 100.

Furthermore, the workpiece carriage 232 in this embodiment need only be suitable for the longitudinal transportation process, so that one can also dispense with the height adjustable transverse running wheels 250.

In the case of this embodiment, the workpiece 106 can remain stationary during both coating processes and it does not have to be moved between the two applications of a coating.

As was the case for the second embodiment, the workpiece 106 in the third embodiment of a coating plant 100 is not moved during the process of applying the coating material, this thereby enabling the coating material to be applied in a particularly uniform manner.

The significant aspect of this embodiment is that use is made of a particularly long work zone 264 in which the dryer portal 266 can be parked.

Moreover, it is also significant that the dryer portal 266 is moved through an area of the work zone 264 in which an application of a coating has taken place.

For the purpose of moving the pre-treatment units 158, the coating units 182 and the dryer portal 266, very long drive rails 156 are used so that all these devices are movable over the entire length of the workpiece 106.

In the event that the pre-treatment and the coating of the workpiece 106 take place in the same zone of the processing booth 102, a common, identical and/or unitary conditioning of the air supply is provided for the pre-treatment process and for the coating process.

In all other respects, the third embodiment of a coating plant 100 that is illustrated in FIG. 10 corresponds in regard to the construction and functioning thereof with the second embodiment that is illustrated in FIG. 9 so that to this extent, reference should be made to the preceding description thereof.

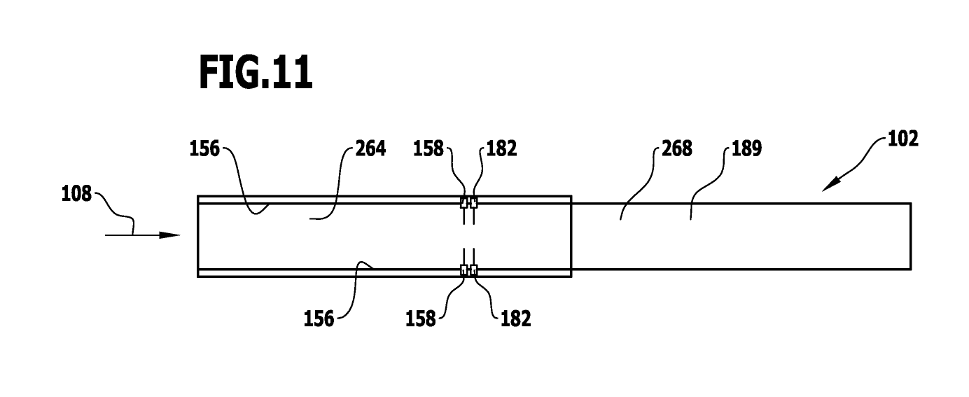

A fourth embodiment of a coating plant 100 which is illustrated in FIG. 11 differs from the second embodiment which is illustrated in FIG. 9 in that there is provided a long convection drying zone 268 which can accommodate the workpiece 106 in its entirety instead of a short drying zone 152 through which the workpiece 106 is continuously moved.

In this convection drying zone 268, the workpiece 106 is not dried by irradiation by means of irradiation devices 192, but rather, by means of warm air which is passed through the convection drying zone 268 by the air circulation system.

In this embodiment, the entirety of the workpiece 106 is first driven into the work zone 264 on the workpiece carriage 232 in the longitudinal direction of advancement 108 and is then brought to a stop therein.

Subsequently, a pre-treatment of the entire workpiece 106 is carried out by means of the movable pre-treatment units 158 and coating of the entire workpiece 106 is carried out by means of the movable coating units 182.

After the process of coating the workpiece 106 has been completely concluded, the workpiece 106 is moved on the workpiece carriage 232 from the work zone 264 into the convection drying zone 268 and is again brought to a stop therein.

The convection drying zone 268 thus forms a drying device 189, relative to which the workpiece 106 is moved after the process of coating the workpiece 106 has concluded and before the process of drying the workpiece 106 begins.

After the drying time necessary for the process of drying by means of warm air, the workpiece 106 is moved out of the convection drying zone 268 on the workpiece carriage 232 in the longitudinal direction of advancement 108 and is thus moved in its entirety out of the processing booth 102 and thereafter, it is returned to the entrance of the processing booth 102 by means of the first transverse conveyor track 120, the return conveyor track 114 and the second transverse conveyor track 130 in the manner described hereinabove in connection with the first embodiment of a coating plant 100, whereupon the workpiece 106 can be driven into the work zone 264 again for a further coating process.

After the second coating process including a second drying process whilst the workpiece 106 remains stationary in the convection drying zone 268, the workpiece 106 is again driven completely out of the processing booth 102 on the workpiece carriage 232 and can then be removed from the workpiece carriage 232.

This embodiment has the advantage that the workpiece 106 does not have to be moved during the process of applying the coating material, whereby a particularly uniform application of the coating material is attainable.

Warm circulating air and/or an IR emitter (infrared emitter) are provided for the process of drying the workpiece 106 in the convection drying zone 268.

In the event that the coating plant 100 in accordance with this embodiment has sufficient space available, two zones arranged one behind the other, namely the work zone 264 and the convection drying zone 268, can each exhibit at least the full length of the workpiece 106.

Drive rails 156 are provided over the entire length of the plant for the purposes of moving the pre-treatment units 158 and the coating units 182 over the entire length of the workpiece 106.

In the event that there are no back-up zones, manual emergency action is only possible to a limited extent in the case of this embodiment.

In the event that pre-treatment and coating of the workpiece 106 take place at the same time in the same zone of the processing booth 102, provision is made for the air supply for the pre-treatment and the air supply for the coating to be conditioned in unitary manner.

Furthermore, use of a dry separation device incorporating pre-coated filter elements is envisaged for a length of the zone used for the application of the coating of less than 10 m.

In all other respects the fourth embodiment of a coating plant 100 that is illustrated in FIG. 11 corresponds in regard to the construction and functioning thereof to the second embodiment that is illustrated in FIG. 9 and so to this extent, reference should be made to the preceding description thereof.

1. A method for providing a workpiece with a coating, wherein the workpiece is an individual part of a given longitudinal extent and the method comprises the following processing steps:
coating the workpiece; and
drying the workpiece by means of a drying device,
wherein the workpiece is moved relative to the drying device after the process of coating the workpiece has begun and before the process of drying the workpiece has terminated,
wherein the workpiece is moved by means of a self-propelled workpiece carriage and
wherein the process of coating the workpiece is effected in a coating zone having a longitudinal extent in the direction in which the workpiece is moved relative to the drying device that is smaller than the longitudinal extent of the workpiece in this direction.

2. A method in accordance with claim 1, wherein the workpiece is moved during the coating process and during the drying process.

3. A method in accordance with claim 1, wherein the workpiece is moved after the process of coating the workpiece is concluded and whilst the workpiece is being dried.

4. A method in accordance with claim 1, wherein the drying device is moved whilst the workpiece is being dried.

5. A method in accordance with claim 1, wherein the workpiece is moved relative to the drying device after the process of coating the workpiece is concluded and before the process of drying the workpiece begins.

6. A method in accordance with claim 1, wherein the workpiece is moved relative to the drying device by means of a track-guided workpiece carriage.

7. A method in accordance with claim 1, wherein the workpiece carriage is moved in a first direction by means of a first set of running wheels and is moved by means of a second set of running wheels in a second direction which is transverse to the first direction.

8. A method in accordance with claim 1, wherein the workpiece carriage is guided on at least one rail which has a curved bearing surface.

9. A method in accordance with claim 1, wherein the workpiece is pre-treated by means of a vacuum suction-jet device prior to the coating process.

10. A method in accordance with claim 1, wherein the process of coating the workpiece is effected in a coating zone in which excess coating material is picked up by an air stream, wherein the superfluous coating material is separated out of the air stream by means of a dry separation device.

11. A method in accordance with claim 1, wherein the coating produced on the workpiece is dried and/or hardened at least partially by means of an irradiation unit.

12. A method in accordance with claim 11, wherein the irradiation unit comprises at least one irradiation device which is movable relative to the coated surface of the workpiece so that the distance thereof from the coated surface of the workpiece is adjustable in variable manner.

13. A method in accordance with claim 1, wherein the process of drying the workpiece is effected in a drying zone having a longitudinal extent in the direction in which the workpiece is moved relative to the drying device that is smaller than the longitudinal extent of the workpiece in this direction.

14. A coating plant for providing a workpiece with a coating wherein said workpiece is an individual part of a given longitudinal extent, in particular for carrying out the method in accordance with claim 1, comprising
at least one coating unit by means of which the workpiece is providable with a coating, and
at least one drying device by means of which the coating on the workpiece is dryable,
wherein the coating plant comprises at least one moving device by means of which a relative movement between the workpiece and the drying device is producible after the process of coating the workpiece has begun and before the process of drying the workpiece has terminated, wherein the coating plant comprises a self-propelled workpiece carriage for moving the workpiece and a coating zone having a longitudinal extent in the direction in which the workpiece is movable relative to the drying device that is smaller than the longitudinal extent of the workpiece in this direction.
